(19) United States
(12) Patent Application Publication
(10) Pub. No.: US 2010/0110481 A1
(43) Pub. Date: May 6, 2010

(54) HOST APPARATUS CONNECTED TO IMAGE FORMING APPARATUS, IMAGE FORMING SYSTEM COMPRISING THE SAME AND MODIFYING METHOD OF BACKGROUND FOR IMAGE FORMING APPARATUS

(75) Inventors: Tae-hoi Do, Suwon-si (KR); Hyun-cheol Park, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/571,631

(22) Filed: Oct. 1, 2009

(30) Foreign Application Priority Data
Nov. 5, 2008 (KR) 2008-0109369

(51) Int. Cl. G06F 3/12; G06K 9/46

(52) U.S. Cl. 358/1.15; 382/190

(57) ABSTRACT

A host apparatus connected to an image forming apparatus, an image forming system including the same and a modifying method of a background for the image forming apparatus, the modifying method including: receiving identification (ID) information of at least one image forming apparatus; determining whether to modify the background by the host apparatus with at least one ID information; and transmitting at least one modifiable background corresponding to at least one image forming apparatus if a modification of the background is to be performed. Thus, the host apparatus connected to the image forming apparatus to determine whether to modify a background according to ID information of the image forming apparatus, transmit the modifiable background to at least one image forming apparatus according to the result can save time and costs as well as providing convenience to a user.

### CROSS-REFERENCE TO RELATED APPLICATIONS

This application claims priority from Korean Patent Application No. 10-2008-0109369, filed on Nov. 5, 2008, in the Korean Intellectual Property Office, the disclosure of which is incorporated herein by reference in its entirety.

### BACKGROUND

1. Field of the Invention

Apparatuses and methods consistent with the present general inventive concept relate to a host apparatus connected to an image forming apparatus, an image forming system comprising the same and a modifying method of a background for the image forming apparatus, and more particularly, to a host apparatus connected to an image forming apparatus which modifies a background by using identification (ID) information of the image forming apparatus, an image forming system comprising the same and a modifying method of a background for the image forming apparatus.

2. Description of the Related Art

An image forming apparatus forms an image to be printed on paper. The image forming apparatus includes a printer, a photocopier, a facsimile, a multi-function device having at least two functions, etc.

Recently, an image forming apparatus which includes a display unit, such as a liquid crystal display (LCD), has been launched.

The display unit displays thereon a background including text informing of various information such as a manufacturer, a model name, a service center or an operation status, or diagrams and background images. The background may include a graphic user interface (GUI) which is generated by execution of a driver or an additional application, and includes a menu item to be inputted by a user.

The image forming apparatus may display information and an operation status thereof through the background and receive a user's command through the menu item.

However, if the menu item should be modified due to change in part of information of the image forming apparatus or due to updated functions, the background of the display unit should also be modified accordingly.

Thus, a conventional image forming apparatus receives the modified background through a network or a local connection and displays the received background on the display unit.

However, while a need for modification of the background occurs with respect to all of a plurality of identical image forming apparatuses, a user should modify the background of the image forming apparatuses one by one according to the conventional modifying method of a background. Such a modification process wastes time and costs, and causes inconvenience to a user with repetitive operations.

### SUMMARY

The present general inventive concept provides a host apparatus connected to an image forming apparatus which determines whether to modify a background according to identification (ID) information of the image forming apparatus, transmits a modified background to at least one image forming apparatus according to a determination result to save time and costs and provides convenience to a user, an image forming system comprising the same and a modifying method of a background for the image forming apparatus.

Additional features and/or utilities of the present general inventive concept will be set forth in part in the description which follows and, in part, will be obvious from the description, or may be learned by practice of the present general inventive concept.

The foregoing and/or other features of the present general inventive concept can be achieved by providing a modifying method of a background for at least one image forming apparatus which is connected to a host apparatus, the modifying method including: receiving identification (ID) information of at least one image forming apparatus; determining whether to modify the background by the host apparatus with at least one ID information; and transmitting at least one modifiable background corresponding to at least one image forming apparatus if a modification of the background is required.

The modifying method may include storing the modifiable background.

The modifying method may include requesting the ID information to at least one image forming apparatus to modify at least one background.

The host apparatus may include a server for administrating a background.

The ID information may include at least one of a device ID, model information and version information of the background of the image forming apparatus.

The background may include at least one of a background image, a menu item, a model name, a manufacturer and service center contact information.

The modifying method may include setting a group including at least one image forming apparatus, and the transmitting the modifiable background may include transmitting the modifiable background to at least one image forming apparatus included in the set group.

The setting the group may include setting a plurality of groups, and the transmitting the modifiable background may include transmitting a modifiable background to the image forming apparatus included in the plurality of groups corresponding to the group of the image forming apparatus.

The foregoing and/or other features of the present general inventive concept may also be achieved by providing a host apparatus which is connected with at least one image forming apparatus, the host apparatus including: a communication unit which receives identification (ID) information of at least one image forming apparatus; a storage unit which stores therein at least one modifiable background corresponding to at least one image forming apparatus; and a controller which determines whether to modify the background by using the at least one received ID information, and controls the communication unit to transmit at least one modifiable background stored in the storage unit to the image forming apparatus if a modification of the background is required.

The controller may control the communication unit to request the ID information to at least one image forming apparatus to modify at least one background.

The host apparatus may include a server to administrate a background.

The ID information may include at least one of a device ID, model information and version information of the background of the image forming apparatus.

The background may include at least one of a background image, a menu item, a model name, a manufacturer and service center contact information.

The host apparatus may include an input unit which sets a group including at least one image forming apparatus, and the communication unit may transmit the modifiable background to at least one image forming apparatus included in the set group.

The input unit may set a plurality of groups, and the communication unit may transmit a modifiable background to the image forming apparatus included in the plurality of groups corresponding to the group of the image forming apparatus.

foregoing and/or other features of the present general inventive concept may also be achieved by providing an image forming system which includes a host apparatus and at least one image forming apparatus, the image forming system including: the host apparatus including a first communication unit to receive ID information of at least one image forming apparatus; a first storage unit to store therein at least one modifiable background corresponding to at least one image forming apparatus; and a first controller to request ID information to the image forming apparatus, to determine whether to modify the background by using the received ID information in response to the request, and to control the first communication unit to transmit at least one modifiable background stored in the storage unit to the image forming apparatus if a modification of the background is required, and the image forming apparatus including a second communication unit to transmit ID information to the host apparatus; and a second controller to control the second communication unit to transmit ID information of the image forming apparatus to the host apparatus according to the request for the ID information and to receive the modifiable background from the host apparatus.

The image forming apparatus may include a display unit, and the second controller may apply the background received from the host apparatus to the display unit.

The image forming apparatus may include a second storage unit, and the second controller may store in the second storage unit the background received from the host apparatus.

The foregoing and/or other features of the present general inventive concept may also be achieved by providing a method of managing backgrounds of a plurality of image forming apparatuses, the method including determining through received ID information whether at least one of a plurality of image forming apparatuses requires updating, and based on the determination, transmitting at least one modifiable background to a corresponding one of the plurality of image forming apparatuses to update the respective background.

The determining whether at least one of a plurality of image forming apparatuses requires updating can be performed through a common host apparatus which sends a request for the ID information to each of the image forming apparatuses connected thereto.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1 is a block diagram of an image forming apparatus according to an exemplary embodiment of the present general inventive concept;

FIG. 2 illustrates an example of a background according to an exemplary embodiment of the present general inventive concept;

FIG. 3 is a block diagram of an image forming system according to an exemplary embodiment of the present general inventive concept; and

FIG. 4 is a flowchart of a modifying method of a background according to an exemplary embodiment of the present general inventive concept.

### DETAILED DESCRIPTION OF THE EMBODIMENTS

Hereinafter, exemplary embodiments of the present general inventive concept will be described with reference to accompanying drawings, wherein like numerals refer to like elements and repetitive descriptions will be avoided as necessary.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

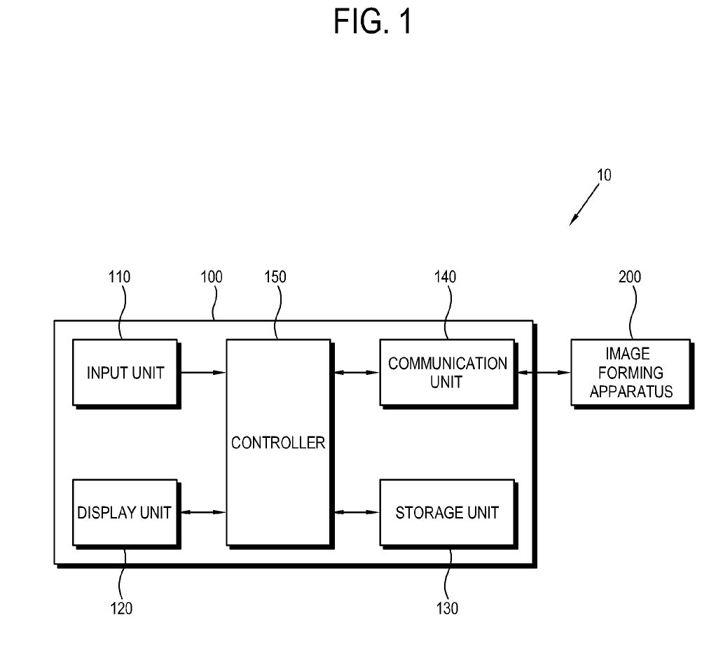

FIG. 1 is a block diagram of a host apparatus 100 according to an exemplary embodiment of the present general inventive concept.

The host apparatus 100 according to the embodiment of FIG. 1 is connected with an image forming apparatus 200 in a wired/wireless network or local connection and performs data communication with at least one image forming apparatus 200. The host apparatus 100 may include a personal computer (PC) or a server, i.e., a server for administrating a background of an image forming apparatus 200, (i.e., a user interface and/or other information).

As shown therein, the host apparatus 100 includes an input unit 110, a display unit 120, a storage unit 130, a communication unit 140 and a controller 150.

The input unit 110 receives various commands from a user. More specifically, a user may input a command through the input unit 110 to transmit a background to at least one image forming apparatus 200.

As an example, the input unit 110 receives an ID and a password for a user login. The controller 150 authenticates a user through the input user ID and password. Here, the host apparatus 100 may execute a login without any additional access limit in an administrator mode in which setting and modification of all environments of the image forming apparatus 200 are available. After executing the login operation in the administrator mode, the host apparatus 100 may access the image forming apparatus 200 remotely and modify the background (i.e., user interface) of the accessed image forming apparatus 200. The host apparatus 100, which is logged-in in the administrator mode, acts as a server to provide administration of a background.

The input unit 110 may include a keyboard, a mouse, etc., as an input device of the host apparatus 100 and may include a graphic user interface (GUI) which is generated by execution of a driver or an additional application and displayed on the display unit 120 to receive a user's input. The display unit 120 displays thereon predetermined current background information of the accessed image forming apparatus 200 and a modifiable background, for a user. Then, a user may determine whether to apply a new background to the accessed image forming apparatus 200 through the input unit 110 corresponding to the displayed current background information. The host apparatus 100 transmits at least one modifiable background to the accessed image forming apparatus 200 according to the determination result.

The display unit 120 may include a liquid crystal display (LCD) and a driver (not shown) to drive the LCD.

The storage unit 130 stores therein identification (ID) information of the accessed image forming apparatus 200 which is connectable to the host apparatus 100, and at least one modifiable background corresponding to the ID information. Here, the ID information may include at least one of a device ID, model information 200 and version information of the background of the image forming apparatus 200.

Here, the model information includes information on a model name of the image forming apparatus 200. For example, if the storage unit 130 stores therein a modifiable background corresponding to the image forming apparatus 200 in a model name starting with SPP, the host apparatus 100 may determine whether to transmit a modifiable background depending on the model information of the image forming apparatus 200 that is connectable to the host apparatus 100.

The storage unit 130 may further store therein version information of a current background of the image forming apparatus 200.

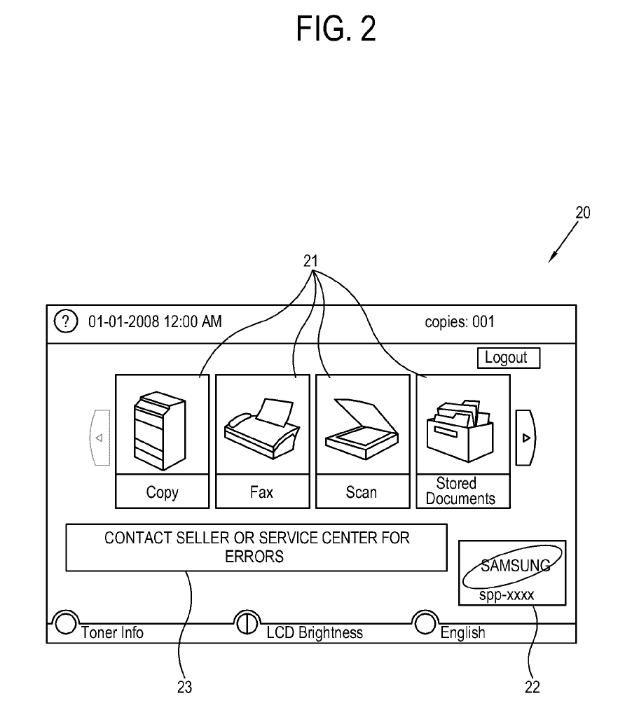

FIG. 2 illustrates an example of a background 20 according to an exemplary embodiment of the present general inventive concept.

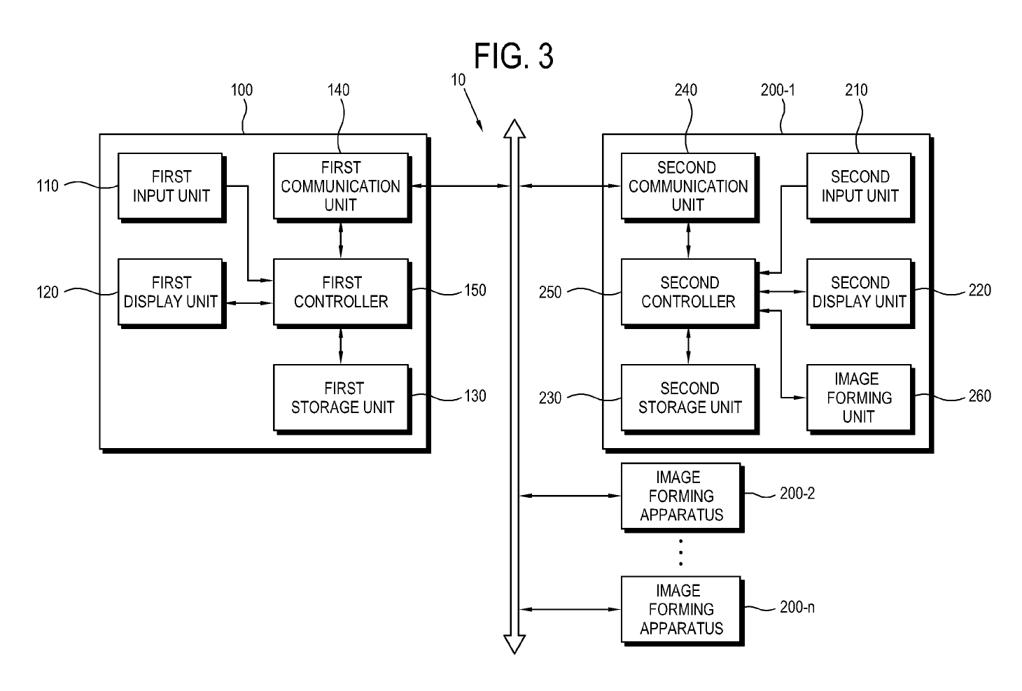

As shown in FIG. 2, the background 20 which is displayed on a display unit 220 (refer to FIG. 3) of the image forming apparatus 200 includes a text or a diagram corresponding to a menu item 21 to select a function of the image forming apparatus 200, a manufacturer and a model name 22 or service center contact information 23. The background 20 may further include a background image which is displayed on a background of the menu item 21 and the text or diagram. Here, the menu item 21 may further include various sub items displayed depending on selection of the menu item 21 in FIG. 2 as well as items to select functions of scanning, copying, etc. as shown in FIG. 2.

Meanwhile, the background according to the present embodiment may further include a GUI which is generated by execution of a driver or an additional application and provided for a user's input. Then, the background 20 which is displayed in the image forming apparatus 200 displays various information and operation status of the image forming apparatus 200.

The storage unit 130 can include a built-in storage medium such as a hard disc drive (HDD) or an external or portable storage medium such as a universal serial bus (USB) memory, or a memory card (memory stick, CF card or MMC).

The communication unit 140 performs wired/wireless communication with the image forming apparatus 200. More specifically, the communication unit 140 transmits the modifiable background stored in the storage unit 130 to the image forming apparatus 200.

The communication unit 140 may request ID information from the image forming apparatus 200 and receive the ID information from the image forming apparatus 200 in response to the request according to a control of the controller 150. The controller 150 determines whether to modify the background of the accessed image forming apparatus 200 with the received ID information, and transmits the modified background to the image forming apparatus 200 based on a determination result. Here, the request may include at least one of a unicast, a broadcast and a multicast.

The communication unit 140 may include a wired/wireless communication module to be connected to the image forming apparatus 200 through a local connection or a network with a predetermined protocol, or a USB port which is connected to a portable storage medium such as a USB memory.

The controller 150 controls the host apparatus 100 as a whole. More specifically, the controller 150 controls the communication unit 140 to request ID information from the image forming apparatus 200 to determine whether to modify the background of the accessed image forming apparatus 200 and receive the requested ID information. The controller 150 determines whether to modify the background according to the received ID information, and controls the communication unit 150 to transmit the modifiable background stored in the storage unit 130 to the accessed image forming apparatus 200 based on the determination result.

If the storage unit 130 stores therein version information of the current background of the accessed image forming apparatus 200, the controller 150 may determine whether to modify the background and transmit the modifiable background to the accessed image forming apparatus 200 according to the result without requesting the ID information from the image forming apparatus 200.

Meanwhile, according to another exemplary embodiment of the present general inventive concept, the controller 150 may uniformly transmit a modifiable background to a plurality of image forming apparatuses which satisfies a predetermined condition.

FIG. 3 is a block diagram of an image forming system 10 including a host apparatus 100 and a plurality of image forming apparatuses 200-1, 200-2, . . . and 200-n according to another exemplary embodiment of the present general inventive concept.

As shown in FIG. 3, the image forming system 10 according to the present embodiment includes a host apparatus 100 and a plurality of image forming apparatuses 200-1, 200-2, . . . and 200-n.

The host apparatus 100 includes a PC or a server, i.e., a server to administrate a background, which can include, as described above, menu items, contact information, model name, a GUI, etc. The plurality of image forming apparatuses 200-1, 200-2, . . . and 200-n may include a printer connectable to a network, a multi-function device performing at least two functions, etc.

In the exemplary embodiments of the present general inventive concept as shown in FIGS. 1 and 3, the configurations performing the same functions may have the same numerals, and description on the elements may commonly apply to the exemplary embodiments in FIGS. 1 and 3.

The host apparatus 100 according to the embodiment of FIG. 3 is connected with the plurality of the image forming apparatuses 200-1, 200-2, . . . and 200-n through a first communication unit 140, and receives ID information from each of the image forming apparatuses 200-1, 200-2, . . . and 200-n. Here, the ID information may include at least one of model information and version information of a currently displayed background of the image forming apparatuses 200-1, 200-2, . . . and 200-n.

The first controller 150 determines at least one of the plurality of image forming apparatuses 200-1, 200-2, . . . and 200-n to modify a background 20 thereof based on received ID information. Here, the first display unit 120 may display the received ID information corresponding to each of the plurality of image forming apparatuses 200-1, 200-2, . . . and 200-n, and a user may determine whether to modify the background of each of the image forming apparatuses 200-1, 200-2, . . . and 200-n through the first input unit 110.

Here, the first controller 150 compares the received ID information with ID information of a background of the first storage unit 130. That is, if a version of the background stored in a predetermined image forming apparatus 200 is lower than that of a background of the first storage unit 130, the first controller 150 determines to transmit a modifiable background to that image forming apparatus.

If a reason for changing the background of a specific image forming apparatus occurs (e.g. added functions) and the received model information conforms to model information of the background of the first storage unit 130, the first controller 150 determines to transmit the modifiable background to that specific image forming apparatus. For example, the first controller 150 may determine to transmit the modifiable background only to image forming apparatuses having a model name starting with SPP, among the plurality of image forming apparatuses 200-1, 200-2, . . . and 200-n, according to the received model information.

The first controller 150 transmits the modifiable background to at least one image forming apparatus, whose background is determined to be changed, based on the determination result as above. The transmitted modifiable background is stored in the first storage unit 130 in advance together with the corresponding ID information.

Here, if the modified background is transmitted to the plurality of image forming apparatuses, the transmission process above uniformly applies to those image forming apparatuses. Accordingly, the image forming system 10 (see FIG. 1) determines the modification of the background and performs the transmission operation to the plurality of image forming apparatuses at a single time, instead of performing repetitive transmission operations to each of the image forming apparatuses according to the determination of modifying the background with respect to the plurality of image forming apparatuses 200-1, 200-2, . . . and 200-n. Thus, time and costs may be saved and user convenience may be improved.

The ID information may be requested periodically, randomly or by a user (administrator).

If the ID information are requested by an administrator, i.e., if a manufacturer (administrator) of the image forming apparatuses intends to modify the background of image forming apparatuses in a specific model only or image forming apparatuses using a specific version only, the host apparatus 100 requests the ID information to each of the image forming apparatuses 200-1, 200-2, . . . and 200-n.

For example, if the image forming apparatuses of a specific model are upgraded and a new menu item is added to the background, if a logo of the manufacturer or a service center contact information change, or if a new background image is updated, the host apparatus 100 (see FIG. 3) requests ID information from each of the image forming apparatuses 200-1, 200-2, . . . and 200-n, and selectively transmits the modifiable background to the image forming apparatuses of a specific model only, image forming apparatuses including a specific model name or image forming apparatuses using a previous background only, according to the received ID information.

If the host apparatus 100 acts as a server and the first storage unit 130 stores therein ID information about image forming apparatuses 200-1, 200-2, . . . and 200-n connectable to the host apparatus 100, the host apparatus 100 may directly transmit the modifiable background to specific image forming apparatuses without requesting the ID information to the image forming apparatuses 200-1, 200-2, . . . and 200-n and without receiving the requested ID information therefrom.

According to another exemplary embodiment of the present general inventive concept, whether to modify the background of the respective image forming apparatuses is determined automatically by the first controller 150 rather than by a user's selection, and only the determination result may be displayed on the first display unit 120.

According to another exemplary embodiment of the present general inventive concept, it may be requested from the host apparatus 100 that the background in one of a plurality of image forming apparatuses 200-1, 200-2, . . . and 200-n be modified, and the modified background may be uploaded to the host apparatus 100 together with ID information. The host apparatus 100 determines whether to apply the background uploaded to one image forming apparatus to another image forming apparatus, and transmits the background to at least one image forming apparatus according to the determination result.

The host apparatus 100 according to embodiments of the present general inventive concept may modify the background of all of the image forming apparatuses 200-1, 200-2, . . . and 200-n connected to the host apparatus 100.

The plurality of image forming apparatuses 200-1, 200-2, . . . and 200-n transmits ID information through a respective communication unit (i.e. 240) provided in each of the image forming apparatuses 200-1, 200-2, . . . and 200-n if the host apparatus 100 requests the ID information.

If the modified background is transmitted to a predetermined image forming apparatus 200-1 through a second communication unit 240 among the plurality of image forming apparatuses 200-1, 200-2, . . . and 200-n, according to the determination result of the host apparatus 100, a second controller 250 stores the received background in a second storage unit 130 and changes the background of the second display unit 220 into the stored background.

Here, the background may be stored or modified by a user's selection through a second input unit 210.

The image forming apparatus 200-1 further includes an image forming unit 260 which forms an image on at least one sheet of paper based on print data according to a print command. Here, the print includes a print to copy a document after a scanning process, a print of received fax data and a print of print data received from the outside through the host apparatus 100 including a server or stored in an HDD or USB memory.

The host apparatus 100 according to an exemplary embodiment may set at least one group including at least one image forming apparatus to be connected to the host apparatus 100. Accordingly, the host apparatus 100 may uniformly transmit a modifiable background to a plurality of image forming apparatuses 200-1, 200-2, . . . and 200-n included in a predetermined group if the image forming apparatuses included in the predetermined group is plural.

If a plurality of groups is set in the image forming system 10 of FIG. 1, the host apparatus 100 may transmit a modifiable background to the image forming apparatus corresponding to the group including the image forming apparatuses 200-1, 200-2, . . . and 200-n. For example, a first background may be transmitted to an image forming apparatus included in a 1F general affair group, and a second background, which is different from the first background, may be transmitted to an image forming apparatus included in a 2F support group. In the same method, if eight groups from Ga to Ha are set in the image forming system 10, each background designated may be transmitted to the eight groups. In some cases, the same modifiable background may be transmitted to at least two of the eight groups.

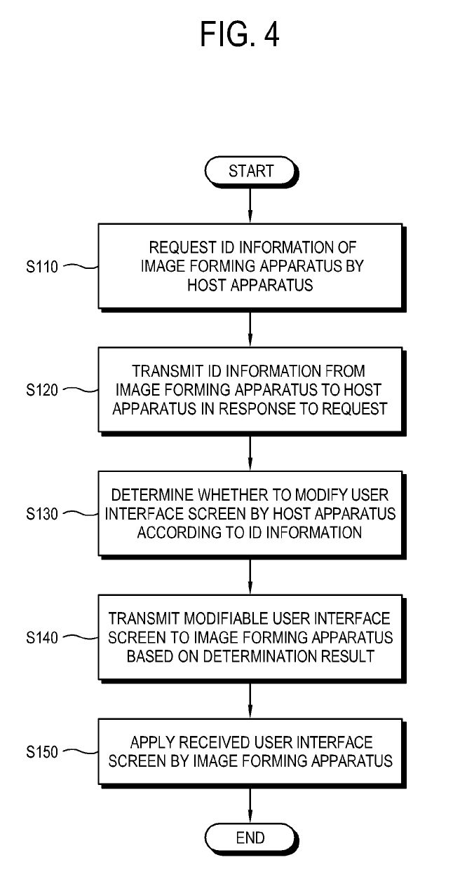

Hereinafter, in the host apparatus 100 with the foregoing configuration and the image forming system 10 including the same, a modifying process of a background for the image forming apparatus 200 will be described with reference to FIG. 4.

As shown therein, the host apparatus 100 may request ID information from at least one of the image forming apparatuses 200-1, 200-2, . . . and 200-n connectable to the host apparatus 100 to modify the background (operation S110). Here, the ID information includes at least one of a device ID, model information and version information of a background of the image forming apparatuses 200-1, 200-2, . . . and 200-n.

The host apparatus 100 receives the ID information from at least one of the image forming apparatuses 200-1, 200-2, . . . and 200-n in response to the request made at operation S110 (operation S120). Here, if the host apparatus 100 acts as a server and stores ID information of at least one of the image forming apparatuses 200-1, 200-2, . . . and 200-n in advance, the request and reception processes at operations S110 and S120 may be omitted.

The host apparatus 100 determines whether to modify the background by using the ID information of the plurality of image forming apparatuses 200-1, 200-2, . . . and 200-n with the ID information (operation S130). Here, the host apparatus 100 may display the ID information for each of the image forming apparatuses 200-1, 200-2, . . . and 200-n for a user's selection or determine the image forming apparatus, whose background is to be modified, regardless of a user's selection. The background 20 may include at least one of a background image, a menu item, a model name, a manufacturer and service center contact information.

The host apparatus 100 transmits the modifiable background to at least one image forming apparatus 200-200-n, whose background is determined to be changed, on the basis of the determination result (operation S140). Here, the background may include a background that is uploaded to the host apparatus 100 from one of the plurality of image forming apparatuses 200-1, 200-2, . . . and 200-n.

The regarding image forming apparatus 200-200-n applies the transmitted modifiable background determined at operation S130 to the background of the second display unit 220 (operation S150). Here, the second controller 250 of the regarding image forming apparatus 200-200-n may store the transmitted modifiable background in the second storage unit 230 of the regarding image forming apparatus 200.

According to an exemplary embodiment of the present general inventive concept, the host apparatus 100 determines whether to modify the background according to the ID information of the plurality of image forming apparatuses 200-1, 200-2, . . . and 200-n, transmits the modified background to at least one image forming apparatus according to the determination result to save time and costs, and provides convenience to a user in modifying the background.

As described above, a host apparatus connected to one or more image forming apparatuses, an image forming system comprising the same and a modifying method of a background for the image forming apparatuses according to the various embodiments allows the host apparatus connected to the one or more image forming apparatuses to determine whether to modify a background according to ID information of each image forming apparatus, transmit the modifiable background to at least one image forming apparatus according to the result to save time and costs and to provide convenience to a user.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A modifying method of a background for at least one image forming apparatus which is connected to a host apparatus, the modifying method comprising:
receiving identification (ID) information of at least one image forming apparatus;
determining whether to modify the background of the at least one image forming apparatus by the host apparatus with at least one ID information; and
transmitting at least one modifiable background corresponding to at least one image forming apparatus if a modification of the background is determined to be required.

2. The modifying method according to claim 1, further comprising:
storing the modifiable background.

3. The modifying method according to claim 1, further comprising:
requesting the ID information of at least one image forming apparatus to modify at least one background.

4. The modifying method according to claim 1, wherein the host apparatus comprises a server to administer a background.

5. The modifying method according to claim 1, wherein the ID information comprises at least one of a device ID, model information and version information of the background of the image forming apparatus.

6. The modifying method according to claim 1, wherein the background comprises at least one of a background image, a menu item, a model name, a manufacturer and service center contact information.

7. The modifying method according to claim 1, further comprising:
setting a group comprising at least one image forming apparatus, wherein
the transmitting the modifiable background comprises transmitting the modifiable background to at least one image forming apparatus included in the set group.

8. The modifying method according to claim 7, wherein the setting the group comprises setting a plurality of groups, and
the transmitting the modifiable background comprises transmitting a modifiable background to the image forming apparatus included in the plurality of groups corresponding to the group of the image forming apparatus.

9. A host apparatus which is connected with at least one image forming apparatus, the host apparatus comprising:
a communication unit which receives identification (ID) information of at least one image forming apparatus;
a storage unit which stores therein at least one modifiable background corresponding to at least one image forming apparatus; and
a controller which determines whether to modify the background of the at least one image forming apparatus by using the at least one received ID information, and controls the communication unit to transmit at least one modifiable background stored in the storage unit to the image forming apparatus if a modification of the background is required.

10. The host apparatus according to claim 9, wherein the controller controls the communication unit to request the ID information to at least one image forming apparatus to modify at least one background.

11. The host apparatus according to claim 9, wherein the host apparatus comprises a server to administer a background.

12. The host apparatus according to claim 9, wherein the ID information comprises at least one of a device ID, model information and version information of the background of the image forming apparatus.

13. The host apparatus according to claim 9, wherein the background comprises at least one of a background image, a menu item, a model name, a manufacturer and service center contact information.

14. The host apparatus according to claim 9, further comprising:
an input unit which sets a group comprising at least one image forming apparatus, wherein
the communication unit transmits the modifiable background to at least one image forming apparatus included in the set group.

15. The host apparatus according to claim 14, wherein the input unit sets a plurality of groups, and
the communication unit transmits a modifiable background to the image forming apparatus included in the plurality of groups corresponding to the group of the image forming apparatus.

16. An image forming system comprising:
a host apparatus comprising:
a first communication unit to receive ID information of at least one image forming apparatus;
a first storage unit to store therein at least one modifiable background corresponding to at least one image forming apparatus; and
a first controller to request ID information to the image forming apparatus to determine whether to modify the background by using the received ID information in response to the request, and to control the first communication unit to transmit at least one modifiable background stored in the storage unit to the image forming apparatus if a modification of the background is required, and
an image forming apparatus comprising:
a second communication unit to transmit ID information to the host apparatus; and
a second controller to control the second communication unit to transmit ID information of the image forming apparatus to the host apparatus according to the request for the ID information and to receive the modifiable background from the host apparatus.

17. The image forming system according to claim 16, wherein the image forming apparatus further comprises a display unit, and
the second controller applies the background received from the host apparatus to the display unit.

18. The image forming system according to claim 16, wherein the image forming apparatus further comprises a second storage unit, and
the second controller stores in the second storage unit the background received from the host apparatus.

19. A method of managing backgrounds of a plurality of image forming apparatuses, the method comprising:
determining through received ID information whether at least one of a plurality of image forming apparatuses requires updating; and
based on the determination, transmitting at least one modifiable background to a corresponding one of the plurality of image forming apparatuses to update the respective background.

20. The method according to claim 19, wherein the determining whether at least one of a plurality of image forming apparatuses requires updating is performed through a common host apparatus which sends a request for the ID information to each of the image forming apparatuses connected thereto.
